(19) United States
(12) Patent Application Publication
(10) Pub. No.: US 2008/0110933 A1
(43) Pub. Date: May 15, 2008

(54) Tamper-indicating dispensing closure

(76) Inventor: Joao Alberto Ferreira Goncalves, Barcelona (ES)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/983,918

(22) Filed: Nov. 13, 2007

Related U.S. Application Data
(60) Provisional application No. 60/858,894, filed on Nov. 14, 2006.

(51) Int. Cl. B67B 5/00; B65D 35/38; B65D 39/00

(52) U.S. Cl. 222/153.05; 220/810; 29/428; 215/237; 222/494

(57) ABSTRACT

A tamper-indicating dispensing closure assembly embodying the principles of the present invention includes a closure body, and an associated pivotal flip-top lid. Notably, the flip-top lid includes an integral hinge member, having a retention portion at a distal end thereof. Closure manufacture is effected by use of an over-molding technique, in conjunction with interlocking geometrical features of the retention portion and the closure body, to ensure proper retention of the lid, while facilitating single-handed manipulation of the lid by consumers.

### CROSS-REFERENCE TO RELATED APPLICATION

This application claims the benefit of priority Provisional Application No. 60/858,894, filed Nov. 14, 2006, the disclosure of which is incorporated herein by reference.

### TECHNICAL FIELD

The present invention relates generally to a dispensing closure assembly having an integrated flip-top lid, and more particularly to a dispensing closure assembly which is formed by over-molding a closure body to an associated flip-top lid to thereby facilitate efficient formation, with the assembly desirably providing tamper-indicating features.

### BACKGROUND OF THE INVENTION

Dispensing plastic closures have come into widespread use by virtue of the convenience by which they permit consumers to readily manipulate the closure for dispensing contents from an associated container. This type of closure typically includes a closure body or shell for fitment to an associated container, with the body defining a dispensing opening through which the contents of the container can be dispensed. This type of closure further includes a flip-top lid (sometimes referred to as a dust cover) pivotally joined to the closure body, such as by a living hinge, so that the lid can be easily moved between open and closed positions with respect to the closure body, thereby opening and closing the dispensing opening. These types of closures are particularly useful on containers for beverages and flowable food products, such as condiments or the like, with the use of deformable (i.e., squeezable) containers further facilitating convenient dispensing.

Closures of this type are exemplified by U.S. Pat. No. 5,685,444, U.S. Pat. No. 6,234,334, and U.S. Pat. No. 6,405,885, the discloses of which are hereby incorporated by reference.

As will be appreciated, it is desirable to provide this type of dispensing closure with a tamper-indicating or tamper-evident feature, whereby consumers can readily visually discern whether the flip-top lid of the closure has been previously opened. While it is known to provide separate seal elements or the like applied to such closures for tamper-indication, the use of such additional sealing elements complicates closure manufacture. It is thus desirable to configure such a dispensing closure to include an integral tamper-indicating arrangement.

At the same time, it is desirable that a closure assembly be configured to facilitate efficient and cost-effective manufacture. To this end, the present invention is directed to a tamper-indicating dispensing closure assembly which can be economically manufactured, while still providing reliable operation, with the closure assembly being easily and conveniently manipulated by consumers, and further avoiding separation of any loose components attendant to tamper-indication during initial opening of the closure.

### SUMMARY OF THE INVENTION

A tamper-indicating dispensing closure assembly embodying the principles of the present invention includes a closure body, and an associated pivotal flip-top lid. Notably, the flip-top lid includes an integral hinge member, having a retention portion at a distal end thereof. Closure manufacture is effected by use of an over-molding technique, in conjunction with interlocking geometrical features of the retention portion and the closure body, to ensure proper retention of the lid, while facilitating single-handed manipulation of the lid by consumers. Notably, tamper-indication is provided by a tamper-indicating latch provided on the flip-top lid with a frangible connection, with the closure body including a retention element for engaging the latch when the flip-top lid is initially moved to its closed position. Upon initial movement of the lid to its open position, the frangible connection fractures to provide tamper-indication.

In accordance with the illustrated embodiment, the present tamper-indicating closure assembly includes a closure body having a top wall portion, and an annular depending skirt portion. The top wall portion defines a dispensing opening for dispensing contents of an associated container to which the closure body is fitted.

The closure assembly further includes a flip-top lid including a main body joined to the closure body for movement between a closed position covering the dispensing opening, and an open position wherein the dispensing opening is uncovered. The flip-top lid includes an integral hinge member joined to the main body, and having a retention portion. Notably, the closure body is over-molded to the retention portion of the hinge member to thereby join the flip-top lid and the closure body to each other. By this arrangement, the flip-top lid and closure body can be formed of similar or dissimilar materials, and may be formed from differently colored polymeric materials, to enhance aesthetic appeal of the assembly, and to further facilitate the tamper-indicating function of the assembly.

To this end, the flip-top lid includes a tamper-indicating latch depending from the main body of the flip-top lid, with the latch joined thereto by a frangible connection. Tamper-indication is further provided by a retention element on the closure body which is provided for engaging the tamper-indicating latch when the flip-top lid is in its closed position. The tamper-indicating latch is retained by the retention element by fracture of the frangible connection.

In the preferred embodiment, the closure body includes a latch protector positioned radially outwardly of the retention element, with the latch protector defining a window. The tamper-indicating latch is configured so that after fracture of the frangible connection, the latch is movable downwardly into the window to provide readily visually discernable evidence of the initial movement of the lid to its open position. The tamper-indicating components of the closure assembly are desirably configured to retain the fractured latch element, thereby desirably avoiding the creation of loose pieces or the like attendant to closure opening.

As noted, efficient closure manufacture is facilitated by over-molding of the closure body on the retention portion of the hinge member of the flip-top lid. In the preferred form, the skirt portion of the closure body defines a lap joint for cooperation with the retention portion of the hinge member to thereby mechanically retain the retention portion generally with the skirt portion. The skirt portion may further include at least one retention knurl on the exterior surface thereof, outwardly of the retention portion of the hinge member, for further mechanically retaining the retention portion generally within the skirt portion.

The present closure assembly may optionally include an elastomeric dispensing valve positioned within the top wall portion of the closure body generally adjacent to the dispensing opening. In one embodiment, the top wall portion of the closure body includes a deformable, internal flange for retaining the dispensing valve in position, with the flange deformed by a suitable process after positioning of the valve within the top wall portion. Alternatively, a valve retaining ring can be provided positioned adjacent to the dispensing valve, with the retaining ring configured for engagement with an interior surface of the top wall portion for retaining the dispensing valve in position.

Other features and advantages of the present invention will become readily apparent from the following detailed description, the accompanying drawings, and the appended claims.

### BRIEF DESCRIPTION OF THE DRAWINGS

FIG. 1 is a perspective view of a closure assembly embodying the principles of the present invention;

FIG. 2 is a further perspective view of the present closure assembly;

FIG. 3 is a cross-sectional view of the present closure assembly, with the flip-top lid of the assembly in an open position;

FIG. 4 is a cross-sectional view of the present closure assembly, with the flip-top lid in the closed position;

FIG. 5 is a cross-sectional view, similar to FIG. 4, illustrating an alternative embodiment of the present closure assembly.

FIG. 6 is a diagrammatic illustration of a surface of a hinge of the type that can be provided in the present closure; and

FIG. 7 shows quadric equations relating to a hinge surface such as illustrated in FIG. 6.

### DETAILED DESCRIPTION

While the present invention is susceptible of embodiment in various forms, there is shown in the drawings, and will hereinafter be described, presently preferred embodiments, with the understanding that the present disclosure is to be considered as an exemplification of the invention, and is not intended to limit the invention to the specific embodiments illustrated.

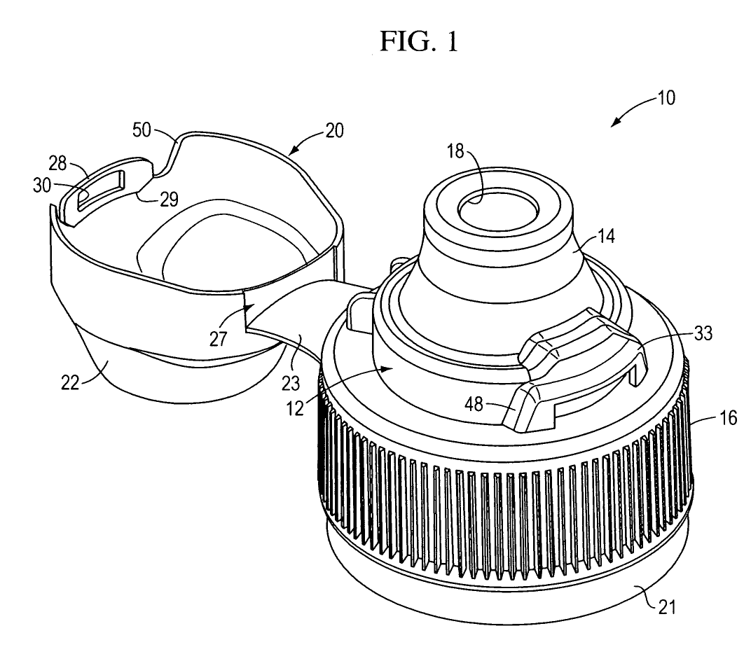

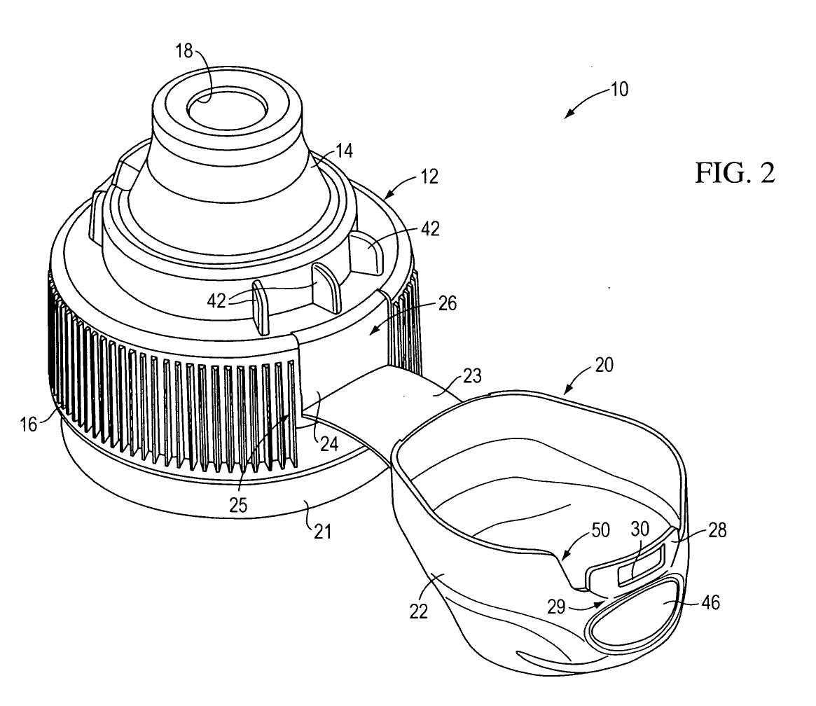

With reference now to FIGS. 1 and 2, therein is illustrated a tamper-indicating dispensing closure assembly 10 embodying the principles of the present invention. As will be recognized by those familiar with the art, dispensing closure assembly 10 is sometimes referred to as a flip-top closure, in that it includes a lid potion which can be moved between an open position and a closed position with respect to a body of the closure, thereby opening and closing a dispensing opening of the closure. This type of closure can be efficiently formed from suitable polymeric material, such as polypropylene, typically by injection molding.

Dispensing closure assembly 10 includes a closure body 12 having a spout-like top wall portion 14, and an annular, depending skirt portion 16. The top wall portion 14 defines a dispensing opening 18 for dispensing the contents from an associated container (not shown) to which the closure body is fitted. To this end, the skirt portion 16 can included an internal thread formation 17, or alternatively, an internal retention bead, internal retention lugs, or like components for effecting securement of the dispensing closure 10 to an associated container. The closure body 12 may further include a tamper-evident flange 21 depending from the skirt portion 16, with the tamper-indicating flange 21 including suitable projections 21′ for cooperation with an associated container. The closure body 12 may also include a depending plug seal element 19 for effecting sealing engagement with an associated container.

The present dispensing closure assembly 10 further includes a flip-top lid 20, sometimes referred to as a dust cover, which includes a main body 22, joined to closure body 12 for movement between a closed position covering dispensing opening 18, and an open position wherein the dispensing opening is uncovered. The lid thus desirably acts to protect the oral contact area of the closure assembly from external contamination.

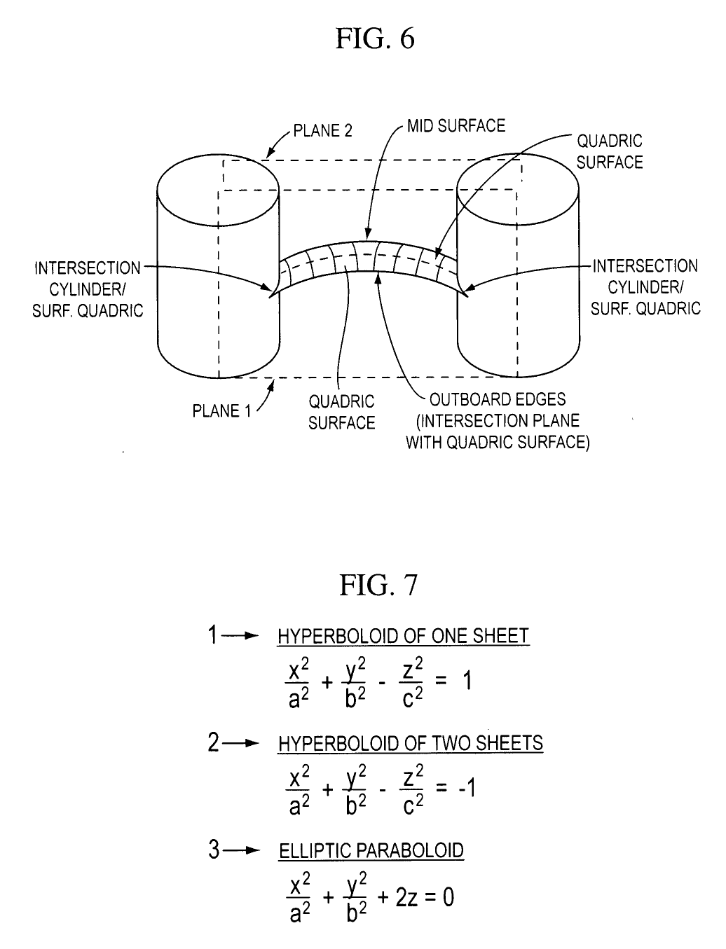

In accordance with the present invention, the flip-top lid 20 includes an integral hinge 23 to which the skirt portion 16 of closure body 12 is over-molded, thus integrating the flip-top lid and the closure body of the closure assembly. The flip-top lid is joined with the closure body by a two-shot over-molding process, whereby the closure assembly is formed as an integrated structure, as the closure body is formed on and about the hinge member 23. In the preferred form, the hinge member 23 of the closure assembly is provided with a hyperbolic configuration to define a saddle-shaped, invertible surface, that is, a hyperbolic saddle surface which can be represented mathematically, thereby allowing the limits of the functionality of the hinge structure to be defined (see FIG. 6).

In particular, the surface of hinge member 23 is defined by quadric equations (FIG. 7) to form a three-dimensional surface whose range is bounded by: (1) the surface between intersections of two parallel cutting planes located at a constant distance on either side of and parallel to a plane formed through major and minor axes; and (2) the surface between intersections of two parallel cylindrical surfaces which form connections between the cap/hinge surface and the shell/hinge (closure body/hinge) surface. The proper functioning of the hinge centers around the distance in curvature between the outboard curves and the central section curve which must have less curvature than the outboard curves, thus creating tensors on the outboard edges which allow the central surface area to invert on itself. A similar situation is apparent at the hinge point curves.

The hinge member 23 includes a retention portion 24 at the distal end thereof which is formed for integration into the skirt potion 16 of closure body 12. The desired integration of the flip-top lid and closure body is facilitated by the provision of a lap joint at 24′ defined by the skirt portion of the closure body for cooperation with the retention portion to mechanically retain the retention portion generally within the skirt portion.

Mechanical integration of the flip-top lid and closure body are further facilitated by the provision of at least one retention knurl 25 on the exterior surface of the skirt portion, generally outwardly of the retention portion 24 of the hinge member, thereby further mechanically retaining the retention portion generally within the skirt portion.

In accordance with the illustrated embodiment, at least one, and preferably each of, the skirt portion 16 of the closure body 12, and the main body 22 of the flip-top lid define a recess within which the hinge member 23 can be positioned when the lid is in its closed position. Each of these recesses functions in the nature of a concealment area, allowing the hinge to be located within the circumferential area of the closure body, or aligned with the surface of the main body of the lid. In the illustrated embodiment, skirt portion 16 defines recess 26, while main body 22 of the flip-top lid defines a recess 27 to provide the desired alignment of the hinge 23.

In accordance with the present invention, the dispensing closure assembly 10 is configured for tamper-indication, that is, to provide readily visually discernable evidence that the flip-top lid 20 has been previously opened after its initial movement into its closed position with respect to closure body 12. To this end, flip-top lid 20 includes a tamper-indicating flange 28 which depends from the main body 22 of the flip-top lid, and is joined thereto by a suitable frangible connection 29, comprising one or more tab bridges which unite the cover with the tamper-evident tab to provide visible detection of tampering.

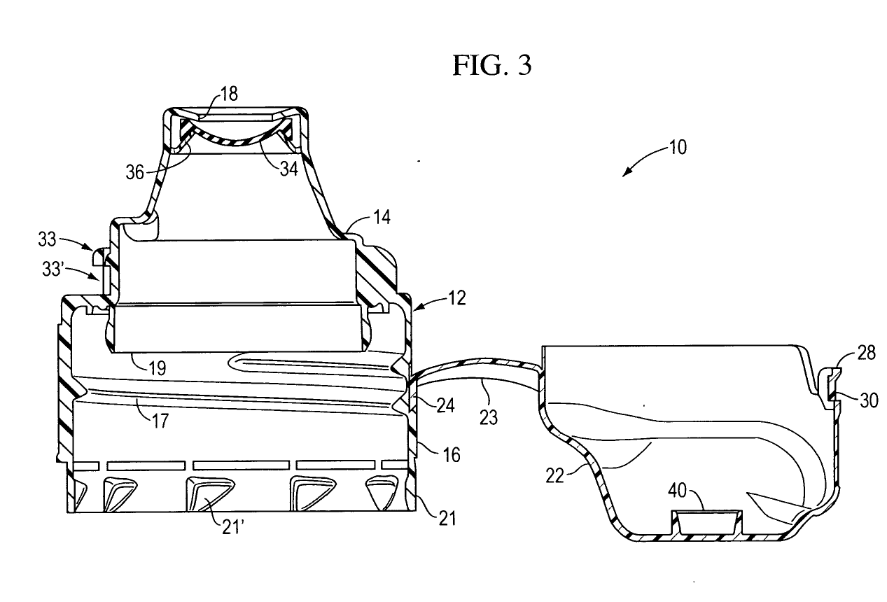

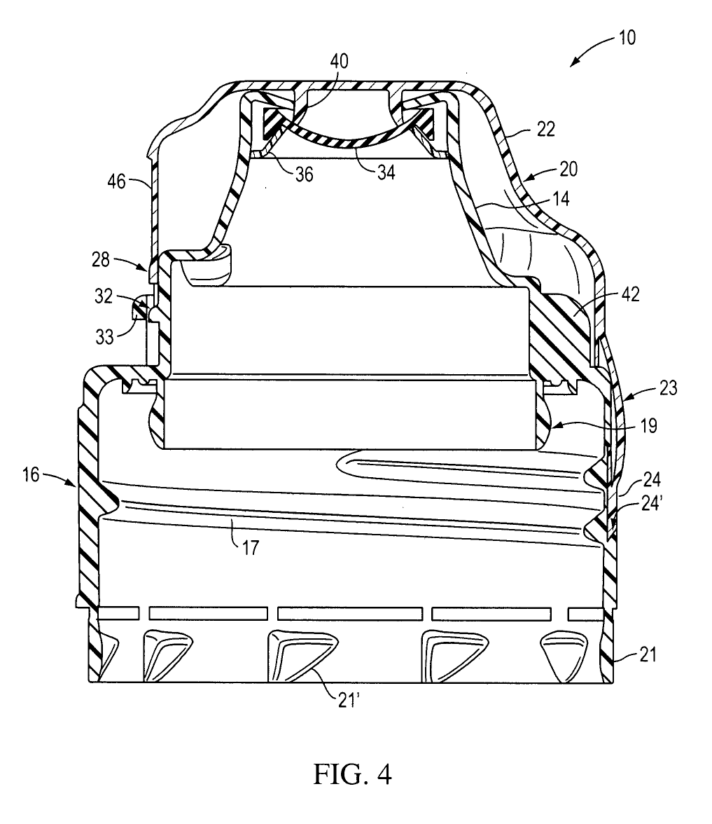

As illustrated, tamper-indicating flange 28 defines an opening 30 for receiving a radially outwardly extending retention element 32 provided on closure body 12. Notably, the closure body includes a latch protector 33 positioned radially outwardly of the retention element 32, with the latch 28 fitting downwardly generally inwardly of the latch protector 33 during initial movement of the flip-top lid 20 to its closed position so that the latch 28 is generally concealed by the protector 33. In this regard, the preferred configuration of the latch 28 is such that the opening 30 defined thereby is sized to receive the retention element 32 therein during initial closing movement. During initial opening movement of the flip-top lid, the frangible connection at 29 fractures, whereby the latch 28 is separated from the flip-top lid, and the lid can be opened for access to the dispensing opening of the closure body. Attendant to this action, the now-separated latch 28 can move downwardly into a window 33′ (FIG. 3) defined by the latch protector 32, thereby providing clear visual evidence that the lid has been moved from its initially closed position to its open position. In a current embodiment, the latch 28 drops down into window 33′ creating a visible 2 mm separation between the lid 20 and the closure body at the frangible connection 29. Moreover, by this arrangement, the fractured latch 28 is retained by the retention element 32 and latch protector 33, thereby avoiding the creation of any loose components attendant to opening of the lid.

Closure assembly 10 may optionally be provided with an elastomeric (silicon) dispensing valve 34 positioned within top wall portion 14 of the closure body 12, generally adjacent to the dispensing opening 18. This type of dispensing valve is known in the art, and can function to control flow of liquid therethrough, typically in response to internal pressurization of an associated container, such as by squeezing or other deformation. The provision of such a valve desirably acts to prevent unnecessary spillage of the contents of the associated container, and controls the flow of the contents, while protecting the contents from external contamination.

In one illustrated embodiment, elastomeric valve 34 is held in position by an internal flange 36 provided on the interior of the top wall portion of the closure body. Internal flange 36 can be initially molded in a position extending generally downwardly and away from dispensing opening 18, with such a configuration permitting insertion of dispensing valve 34 into position adjacent the dispensing opening. The internal flange 36 can thereafter be deformed, such as by use of a suitable swaging tool or the like, whereby the flange is moved into the disposition, such as illustrated in FIG. 3, extending generally toward the dispensing opening, thereby engaging and retaining an annular portion of the dispensing valve 34.

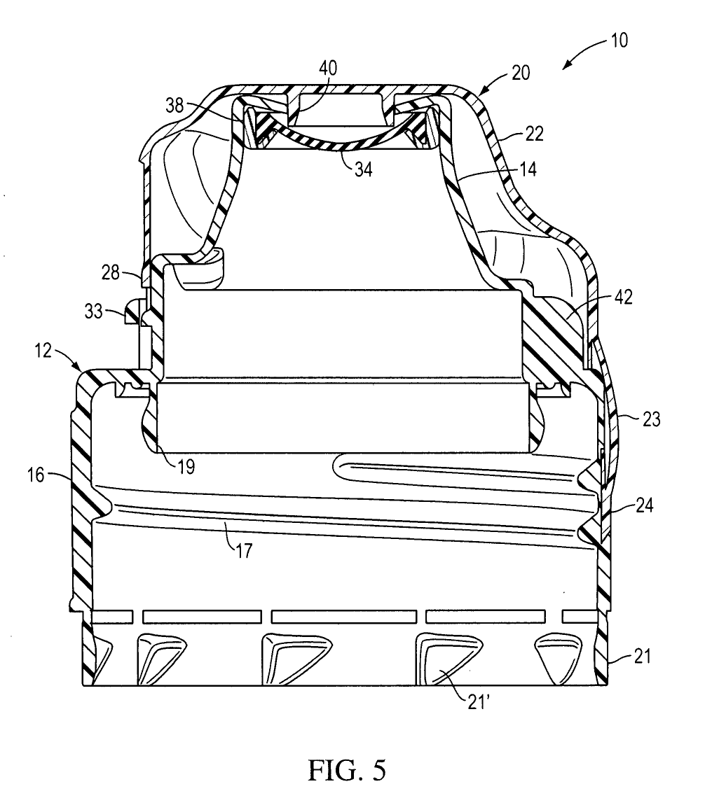

Alternatively, as illustrated in FIG. 5, dispensing valve 34 can be provided with a valve retaining ring 38 positioned adjacent to the dispensing valve. Valve retaining ring 38 is configured for engagement with an interior surface of the top wall portion 14 of the closure body for thereby retaining the dispensing valve in position.

In the preferred form, the main body 22 of the flip-top lid includes a depending plug seal element 40 which is received within dispensing opening 18 in the closed position of the main body of the flip-top lid. Plug seal 40 desirably acts to prevent unnecessary spillage of the contents of the associated container, while protecting the contents from external contamination and can be desirably configured for a snap-fit into the dispensing opening after initial opening of the flip-top lid.

Other features of the present closure assembly facilitates convenient, preferably single-hand, manipulation by consumers. Closure body 12 is preferably provided with a plurality of alignment ribs 42 which desirably act to align the lid with the closure body. Upon closing of the lid, the lid abuts the alignment ribs 42, and the ribs, in turn, force the lid into proper closing position by restricting lateral movement, and ensuring that the hinge 23 is contained within the hinge concealment area provided by recess 26. A non-slip thumb recess 44 on the main body 22 of the flip-top lid facilitates single-hand/thumb opening of the lid, while a cover finger closing area 46 allows ergonomic single-hand closing of the cover. Shoulder 48 on the closure body cooperates with surfaces 50 on the cover to facilitate alignment and closing of the cover.

As noted, manufacturing of the present closure assembly can be efficiently effected by a two-shot over-molding process, thus facilitating the use of two dissimilar materials and/or colors for the flip-top lid and the closure body. Manufacture in this manner can be effected by a core rotating and over-molding technique. The two-shot over-molding process involves injecting the flip-top lid/hinge component, allowing this component to solidify, and upon solidification repositioning and securing the part of the solidified component within another distinct cavity/core mold. Thereafter, the main body of the closure is formed by injection of the second material, thus enveloping the retention portion 24 of the hinge 23 within the second material. This process produces the part in an open position, whereby an in-mold closing action is preferably formed, with the closed closure assembly subsequently ejected from the mold to produce the final product.

Thus, the present method contemplates providing a flip-top lid, including a main body joined to an integral hinge member having a retention portion, and positioning the retention portion in an associated mold. The method further contemplates molding of a closure body having a top wall portion and an annular, depending skirt portion so that the skirt potion is joined to the retention portion of the hinge member, with the top wall portion defining a dispensing opening for dispensing contents of an associated container to which the closure body is fitted. In this manner, the main body of the flip-top lid is joined to the closure body for movement between the closed position covering the dispensing opening, and an open position wherein there dispensing opening is uncovered.

As noted, it is preferred that the closure body is molded with the main body of the flip-top lid in the open position, with the main body thereafter being moved to the closed position.

In accordance with the preferred form, the present method contemplates providing the flip-top lid with a tamper-indicating flange depending from the main body of the flip-top lid, with the flange joined thereby by a frangible connection. The present method contemplates that the closure body is formed with a retention element, element 32 in the illustrated embodiment, for engaging the tamper-indicating latch when the flip-top lid is in the closed position, with the latch being retained by the retention element by fracture of the frangible connection when the flip-top lid is initially moved from its closed position to its open position.

From the foregoing, it will be observed that numerous modifications and variations can be effected without departing from the true spirit and scope of the novel concept of the present invention. It is to be understood that no limitation with respect to the specific embodiment illustrated herein is intended or should be inferred. The disclosure is intended to cover, by the appended claims, all such modifications as fall within the scope of the claims.

What is claimed is:

1. A tamper-indicating dispensing closure assembly, comprising:
a closure body having a top wall portion, and an annular depending skirt portion, said top wall portion defining a dispensing opening for dispensing contents of an associated container to which the closure body is fitted; and
a flip-top lid including a main body joined to said closure body for movement between a closed position covering said dispensing opening, and an open position wherein said dispensing opening is uncovered,
said flip-top lid including an integral hinge member joined to said main body and having a retention portion, said closure body being over-molded on said retention portion to thereby join said flip-top lid and said closure body to each other.

2. A tamper-indicating, dispensing closure assembly in accordance with claim 1, wherein:
said flip-top lid includes a tamper-indicating latch depending from said main body of said flip-top lid, and joined thereto by a frangible connection,
said closure body a retention element for engaging said tamper-indicating latch when said flip-top lid is in said closed position, said tamper-indicating latch being retained by said retention element by fracture of said frangible connection when said flip-top lid is initially moved from said closed position to said open position.

3. A tamper-indicating, dispensing closure assembly in accordance with claim 2, wherein:
said retention element extends generally radially outwardly of said closure body.

4. A tamper-indicating, dispensing closure assembly in accordance with claim 2, wherein:
said closure body includes a latch protector positioned radially outwardly of said retention element.

5. A tamper-indicating, dispensing closure assembly in accordance with claim 4, wherein:
said latch protector defines a window, said latch being movable downwardly into said window after fracture of said frangible connection to indicate initial movement of said flip-top lid from said closed position to said open position.

6. A tamper-indicating, dispensing closure assembly in accordance with claim 1, wherein:
said closure body includes at least one alignment element positioned generally adjacent to said hinge member, said main body of said flip-top lid being engageable with said alignment element during movement from said open position to said closed position to facilitate alignment of said main body with said closure body.

7. A tamper-indicating, dispensing closure assembly in accordance with claim 1, wherein:
at least one of said main body of said flip-top lid and said closure body defines a recess for receiving said hinge member in the closed position of said main body.

8. A tamper-indicating, dispensing closure assembly in accordance with claim 1, wherein:
said skirt portion of said closure body defines a lap joint for cooperation with said retention portion of said hinge member to mechanically retain said retention portion generally within said skirt portion.

9. A tamper-indicating, dispensing closure assembly in accordance with claim 8, wherein:
said skirt portion further includes at least one retention knurl on the exterior surface thereof outwardly of said retention portion of said hinge member for further mechanically retaining said retention portion generally within said skirt portion.

10. A tamper-indicating, dispersing closure assembly in accordance with claim 1, including:
a dispensing valve positioned within the top wall portion of said closure body generally adjacent to said dispensing opening.

11. A tamper-indicating, dispensing closure assembly in accordance with claim 10, wherein:
said top wall portion of said closure body includes an internal flange for retaining said dispensing valve in position.

12. A tamper-indicating, dispensing closure assembly in accordance with claim 10, including:
a valve retaining ring positioned adjacent said dispensing valve and in engagement with an interior surface of said top wall portion of said closure body for retaining said dispensing valve in position.

13. A tamper-indicating, dispersing closure assembly in accordance with claim 1, wherein:
said closure body includes a depending plug seal element.

14. A tamper-indicating, dispensing closure assembly in accordance with claim 1, wherein:
said main body of said flip-top lid includes a depending plug seal element received within said dispensing opening in the closed position of said main body of said flip-top lid.

15. A tamper-indicating, dispensing closure assembly in accordance with claim 1, wherein:
said hinge member has a generally saddle-shaped, invertible surface.

16. A method of assembling a tamper-indicating dispensing closure assembly, comprising the steps of:
providing a flip-top lid including a main body joined to an integral hinge member having a retention portion,
positioning said retention portion in an associated mold, and
molding a closure body having a top wall portion, and an annular depending skirt portion so that said skirt portion is joined to the retention portion of the hinge member, said top wall portion defining a dispensing opening for dispensing contents of an associated container to which the closure body is fitted;
whereby said main body of said flip-top lid is joined to said closure body for movement between a closed position covering said dispensing opening, and an open position wherein said dispensing opening is uncovered.

17. A method of assembling a tamper-indicating dispensing closure assembly, in accordance with claim 16, including:
molding said closure body with said main body of said flip-top lid in said open position, and thereafter moving said main body to said closed position.

18. A method of assembling a tamper-indicating dispensing closure assembly, in accordance with claim 17, including:
providing said flip-top lid with a tamper-indicating latch depending from said main body of said flip-top lid, and joined thereto by a frangible connection, and
molding said closure body with a retention element for engaging said tamper-indicating latch when said flip-top lid is in said closed position, said tamper-indicating latch being retained by said retention element by fracture of said frangible connection when said flip-top lid is initially moved from said closed position to said open position.
